(19) United States
(12) Patent Application Publication
(10) Pub. No.: US 2025/0259039 A1
(43) Pub. Date: Aug. 14, 2025

(54) MACHINE LEARNING TECHNOLOGIES TO ACCURATELY MATCH SHIPMENTS WITH SPECIFIC VEHICLES

(71) Applicant: PROJECT 44, LLC, Chicago, IL (US)

(72) Inventor: Stephanie Elizabeth Kirmer, Chicago, IL (US)

(21) Appl. No.: 18/441,972

(22) Filed: Feb. 14, 2024

(51) Int. Cl. G06N 3/0464; G06Q 10/0833

(52) U.S. Cl. CPC G06N 3/0464; G06Q 10/0833

(57) ABSTRACT

Systems and methods for employing machine learning techniques to match equipment identifications are provided. According to certain aspects, a server analyzes, using a trained machine learning model, a customer-provided equipment ID to determine a possible equipment ID match. The server determines that the possible equipment ID match is aligned with an equipment ID expected by a carrier entity. The server retrieves tracking information for that equipment via a tracking device installed in the equipment, and tracks the corresponding shipment accordingly.

### FIELD

The present disclosure is directed to improvements to logistics tracking technologies. More particularly, the present disclosure is directed to machine learning technologies for matching customer-provided equipment IDs to equipment IDs associated with a carrier entity in association with tracking equipment related to shipping agreements.

### BACKGROUND

The transportation and logistics industry is made up of various entities that contract or agree to handle the transportation of physical items between and among locations. In particular, the transportation and logistics industry generally includes shippers (i.e., entities having physical items to transport) and carriers (i.e., entities having transport equipment to transport the physical items). There are additional entities known as third-party logistics (3PL) entities that receive quote requests from shippers, determine rates offered by the carriers to accommodate the requests, and ultimately broker shipping agreements between a shipper and a carrier. Communication among the shippers, 3PL entities, and carriers may be facilitated using Transportation Management Systems (TMS).

Equipment identifications (IDs) play a crucial role in tracking shipments in this industry. These IDs are unique identifiers assigned to various types of equipment used in the transportation of goods, such as containers, trailers, and even individual packages. The primary purpose of equipment IDs is to streamline the logistics process, enhance efficiency, and improve the overall visibility of shipments throughout the supply chain.

When a shipper releases a loaded container or trailer to a carrier for transport by an equipment, the two parties must agree on the ID(s) of the equipment transporting the goods. If there is a mismatch between the equipment ID expected by the carrier and the ID of the equipment supplied by the shipper, problems ensue. In particular, mismatched equipment IDs frequently lead to untracked shipments as well as false positive tracking events in shipment monitoring systems. Other problems can also occur due to mismatched equipment IDs, such as capacity imbalances, security issues, and decreased asset utilization, among others.

Therefore, there is an opportunity for platforms and technologies to automatically, effectively, and efficiently match equipment IDs.

### SUMMARY

In an embodiment, a computer-implemented method of employing machine learning to track shipping equipment is provided. The computer-implemented method may include: accessing a set of training data comprising a plurality of customer-associated equipment identifications (IDs) matched with a plurality of carrier-specific equipment IDs; training, by at least one processor, a machine learning model using the set of training data; receiving, by the at least one processor, an equipment ID related to a shipping agreement specifying the transportation of a set of goods by a carrier entity; analyzing, by the machine learning model that was trained, the equipment ID to determine a possible matching equipment ID specific to the carrier entity; determining, by the at least one processor, that the possible matching equipment ID matches an identification of an equipment specific to the carrier entity; and receiving, by the at least one processor, tracking information corresponding to the equipment specific to the carrier entity, wherein the tracking information is generated by a tracking device installed in the equipment specific to the carrier entity.

Further, in an embodiment, a system for employing machine learning to track shipping equipment is provided. The system may include a memory storing (i) a set of computer-readable instructions, and (ii) a set of training data comprising a plurality of customer-associated equipment identifications (IDs) matched with a plurality of carrier-specific equipment IDs. Further, the system may include at least one processor interfaced with the memory, and configured to execute the set of computer-readable instructions to cause the at least one processor to: train a machine learning model using the set of training data, receive an equipment ID related to a shipping agreement specifying the transportation of a set of goods by a carrier entity, analyze, by the machine learning model that was trained, the equipment ID to determine a possible matching equipment ID specific to the carrier entity, determine that the possible matching equipment ID matches an identification of an equipment specific to the carrier entity, and receive tracking information corresponding to the equipment specific to the carrier entity, wherein the tracking information is generated by a tracking device installed in the equipment specific to the carrier entity.

In a further embodiment, a non-transitory computer-readable storage medium configured to store instructions executable by a computer processor is provided. The instructions may include: instructions for accessing a set of training data comprising a plurality of customer-associated equipment identifications (IDs) matched with a plurality of carrier-specific equipment IDs; instructions for training a machine learning model using the set of training data; instructions for receiving an equipment ID related to a shipping agreement specifying the transportation of a set of goods by a carrier entity; instructions for analyzing, by the machine learning model that was trained, the equipment ID to determine a possible matching equipment ID specific to the carrier entity; instructions for determining that the possible matching equipment ID matches an identification of an equipment specific to the carrier entity; and instructions for receiving tracking information corresponding to the equipment specific to the carrier entity, wherein the tracking information is generated by a tracking device installed in the equipment specific to the carrier entity.

### BRIEF DESCRIPTION OF THE FIGURES

FIG. 1 depicts an overview of components and entities associated with the systems and methods, in accordance with some embodiments.

FIG. 2 depicts an example signal diagram associated with matching equipment IDs, in accordance with some embodiments.

FIG. 3 depicts an exemplary deep learning artificial neural network (DNN) that may be employed by the systems and methods, in accordance with some embodiments.

FIG. 4 illustrates an example flow diagram of employing machine learning to track shipping equipment, in accordance with some embodiments.

FIG. 5 depicts an example chart that includes matched equipment IDs, in accordance with some embodiments.

FIG. 6 is an example hardware diagram of a server configured to perform various functionalities, in accordance with some embodiments.

### DETAILED DESCRIPTION

The present embodiments may relate to, inter alia, improved shipment tracking technologies. According to certain aspects, the systems and methods employ a machine learning technique that trains a machine learning model using training data that matches customer-associated equipment IDs with carrier-specific equipment IDs. The trained machine learning model may analyze a subject equipment ID associated with a shipping agreement, and output a possible matching equipment ID that is specific to a carrier entity that is transporting a set of goods specified by the shipping agreement. In the event that the possible matching equipment ID matches an equipment ID of an equipment associated with the carrier entity, the systems and methods may track the equipment using tracking information that is generated by a tracking device installed in the equipment.

Equipment IDs are essential identifiers in the shipping industry that link tracking devices to specific vehicles, enabling real-time visibility and compliance monitoring of fleet equipment like trucks and trailers. Generally, a shipper initially provides an equipment ID for an equipment (e.g., a truck or another vehicle) to a third-party logistics partner (3PL) when first onboarding the equipment into the transportation management system of the 3PL. In some embodiments, this equipment ID may originate from the manufacturer or equipment owner. The 3PL logs or records this equipment ID, perhaps alongside a set of asset specifications, to identify and associate that equipment throughout its lifecycle in its transportation management system.

For the 3PL to be able to track that particular equipment, the equipment ID must be correctly paired with its corresponding device ID registered on the tracking hardware installed on the equipment (e.g., in the truck cabin) supplied by an external electronic logging device (ELD) provider. If an incorrect, inaccurate, incomplete, or non-existent equipment ID is provided during activation or onboarding, the ELD provider will return an error indicating failure associating that ID, which prevents reliable linkage between the equipment and tracking signals generated by the ELD.

Without a successful pairing between an equipment ID initially provided by the shipper to an ELD device that is reporting tracking information during shipment, the 3PL has limited visibility. In particular, if the 3PL lacks reliable real-time tracking and definitive vehicle identification, it cannot verify transportation sequences, monitor compliance milestones, or prove chain of custody. This impedes dynamic ETAs, efficient load matching, regulatory reporting, and optimized utilization for the 3PL and its customers. Maintaining current fleetwide equipment ID sync between 3PLs and external telematics partners is therefore imperative for responsive logistics.

The systems and methods represent a technology that improves on conventional shipping tracking technologies in many respects. Generally, the systems and methods address a common challenge in logistics where discrepancies between provided and expected equipment IDs lead to a lack of visibility and hinder effective tracking. One improvement offered by the systems and methods is the mitigation of data inconsistencies, which are a major source of disruptions in the logistics chain. By automatically aligning the equipment ID to the expectations of the carrier, the systems and methods ensure accurate and standardized tracking information, which not only reduces errors but also streamlines communication among shippers, carriers, and third-party logistics providers (3PLs). With a unified and consistent identification system, the 3PL can seamlessly integrate the tracking data into its systems, providing real-time updates to shippers without delays that are commonly caused by manual reconciliation efforts.

Further, the technology facilitates increased transparency throughout the supply chain, as shipment tracking becomes more reliable which enables better decision-making and improved customer service. The 3PL gains the ability to proactively address any issues that may arise during transit, as it now has accurate and timely information about the progress of each shipment. This proactive approach can lead to more efficient problem resolution, reducing the likelihood of disruptions and enhancing overall customer satisfaction.

Additionally, the automated adjustment of equipment IDs is accomplished via digitization and automation. By adding this technology to conventional tracking systems, logistics operations ultimately improves the accuracy, efficiency, security and reliability of logistics data management.

In particular, the systems and methods optimize data consistency in logistics technologies. By automating the alignment of equipment IDs with carrier expectations, the system not only minimizes errors but also reduces the strain on network traffic. The streamlined and standardized tracking information becomes more seamlessly integrated into the systems of a 3PL and other entities, enhancing the overall reliability of data and decreasing the likelihood of network congestion.

In terms of security, the automated adjustment and matching of equipment IDs ensures that the information exchanged between shippers, carriers, and 3PLs adheres to a standardized and secure identification system. This not only prevents potential security breaches resulting from manual errors or inconsistencies but also aligns with industry best practices for safeguarding sensitive logistics data. Furthermore, the claimed technologies extend to transparency and efficiency in supply chain operations, with a clear link to computer software advancements. Moreover, the automated adjustment process facilitates real-time updates, enabling for more responsive decision-making in logistics.

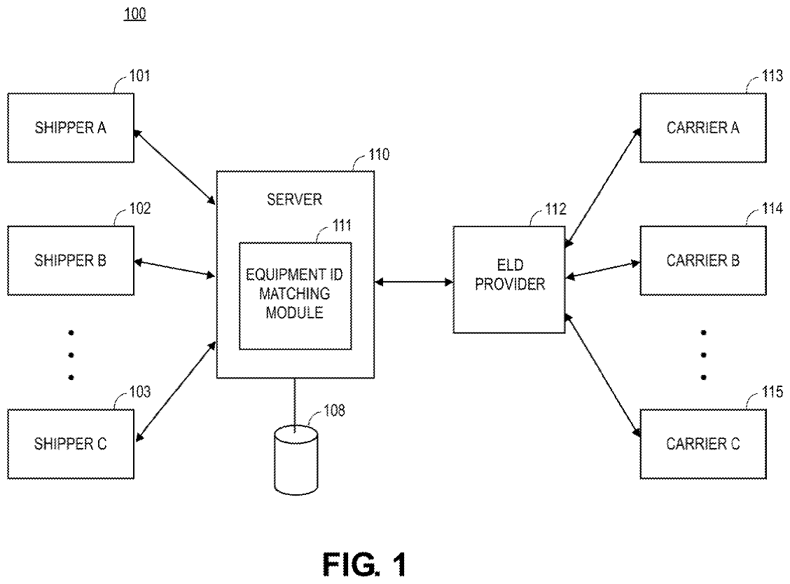

FIG. 1 illustrates an overview of a system 100 of components configured to facilitate the systems and methods. It should be appreciated that the system 100 is merely exemplary and that alternative or additional components are envisioned.

As illustrated in FIG. 1, the system 100 includes a set of shipper entities 101, 102, 103 that may be configured to communicate with a server 110. It should be appreciated that each of the set of shipper entities 101, 102, 103 may include one or more server computers or components that may communicate data to and receive data from the server 110. While FIG. 1 illustrates shipper A 101, shipper B 102, and shipper C 103, it should be appreciated that additional or alternative shippers are envisioned.

Generally, each of the set of shipper entities 101, 102, 103 may be operated or managed by a company, corporation, business, entity, individual, group of individuals, and/or the like that may manufacture, supply, or otherwise have access to physical goods, supplies, materials, animals, and/or other items (generally, “physical goods”) capable of being physically transported. Generally, each of the set of shipper entities 101, 102, 103 may intend to have transported a set of physical goods from an origin location to a destination location, where the set of physical goods may have an associated weight, dimensions, and/or other parameters.

The server 110 may be operated or managed by a third-party logistics (3PL) entity. Generally, a 3PL entity may be a third-party provider that the set of shipper entities 101, 102, 103 may use to outsource certain elements associated with handling and managing the transportation of the physical goods, where the 3PL entity may manage the fulfillment of shipping requests that originate from the set of shipper entities 101, 102, 103. In particular, the 3PL entity may manage operation, warehousing, and transportation services which may be scaled and customized to customers' needs based on certain market conditions, such as the demands and delivery requirements for products and materials, and may manage one or more particular functions within supply management, such as warehousing, transportation, or raw material provision. The 3PL entity may be a single service or may be a system-wide bundle of services capable of managing various aspects of a supply chain (e.g., transportation of physical goods).

The system 100 may further include an electronic logging device (ELD) provider 112 that may be configured to communicate with the server 110 as well as with a set of carrier entities (as shown: carrier A 113, carrier B 114, and carrier C 115). Each of the carrier entities 113, 114, 115 may be operated or managed by a company, corporation, business, entity, individual, group of individuals, and/or the like that owns or otherwise has access to equipment (e.g., a set of vehicles) capable of transporting physical goods. According to embodiments, the transportation of goods may be accomplished via marine or water (i.e., using boats or ships), air (i.e., using aircraft), rail (i.e., using trains), or road (i.e., using trucks, cars, or other land-based vehicles). The term “equipment,” as used herein, may refer to any vehicle, vessel, or craft capable of transporting goods via marine or water, air, rail, and/or road. The shipments of the goods may be categorized differently. Generally, freight shipments may be specific to trucks and may be categorized as less than truckload (LTL) or truckload (TL). Typically, but not always, LTL shipments may range from fifty (50) to 7,000 kg in weight and 2.5 to 8.5 m in dimension, where trailers used in LTL shipments may range from 8.5 to 16.5 m, and where the shipments may be palletized, shrink-wrapped, and packaged. TL shipments are typically, but not always, larger than 7,000 kg, and may consist of physical goods that may be shipped using a single loaded truck.

The server 110 may implement or otherwise operate a transportation management system TMS. Generally, the TMS may be any of a general transportation management system, warehouse management system (WMS), order management system (OMS), enterprise resource planning (ERP) system, or otherwise a system that may be used to manage freight. Further, the TMS may at least partly facilitate shipping agreements between the set of shipper entities 101, 102, 103 and the set of carrier entities 113, 114, 115, where the TMS may facilitate route planning and optimization, load optimization, execution, freight audit and payment, yard management, advanced shipping, order visibility, and carrier management. The TMS may be an open-source system or may be proprietary to any of the set of shipper entities 101, 102, 103 or the 3PL. According to embodiments, the TMS may support specific and particular communication capabilities with the other entities of the system 100. In particular, the TMS may support communication with the other entities via different components and protocols.

The ELD provider 112 may be operated or managed by a company, corporation, business, entity, individual, group of individuals, and/or the like that develops certified hardware and software for tracking driver hours of service (HOS), such as to meet federal compliance mandates. Generally, the 3PL entity may leverage the ELD provider 112 to equip asset fleets (i.e., equipment) and collect telematics data needed for transportation management and regulatory adherence. Further, the ELD provider 112 may mandate ELD usage for the set of carrier entities 113, 114, 115 who are handling freight of the set of shipper entities 101, 102, 103, such as to ensure safety and accountability. Additionally, the set of carrier entities 113, 114, 115 may adopt solutions provided by the ELD provider 112 to capture driving logs, hours tracking, vehicle diagnostics.

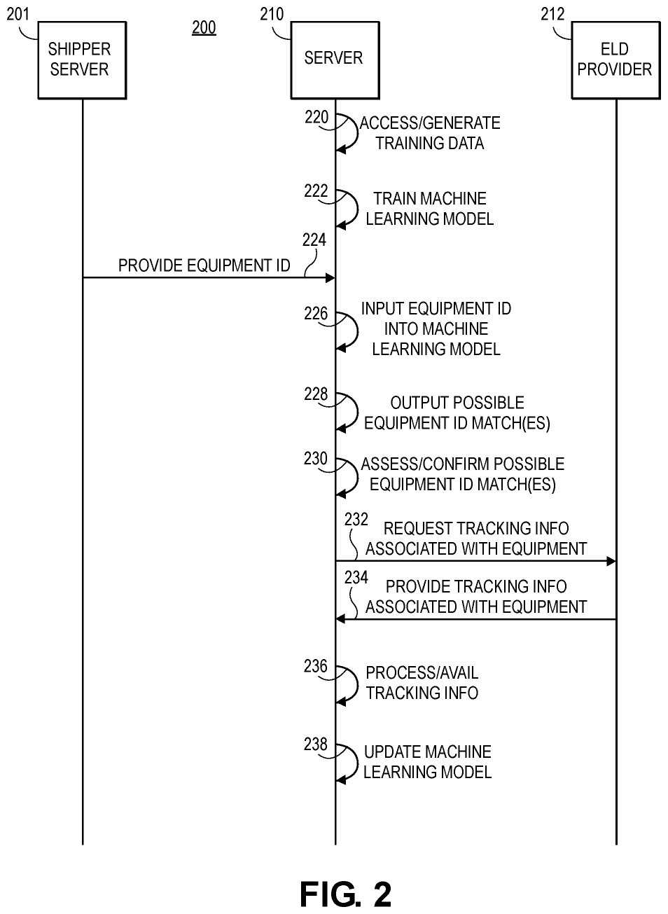

According to embodiments, the server 110 may support execution of an equipment ID matching module 111 which may be configured to, using machine learning techniques, match identifications of equipment provided by the set of shipper entities 101, 102, 103 with identifications of equipment that are association with the set of carrier entities 113, 114, 115. These functionalities are further described with respect to FIG. 2.

The equipment ID matching module 111 (or more generally, the server 110) may interface with a database 108 or other type of memory configured to store data accessible by the equipment ID matching module 111 (or the server 110). In embodiments, the database 108 may store data associated with training and using a machine learning model, as well as any equipment identifications that are received, communicated, and/or tested, and/or other data.

An entity (e.g., a customer of the 3PL entity) may use a computing device(s) (not shown in FIG. 1) to access to a dashboard, interface, or the like that may indicate matches or non-matches of equipment IDs. In embodiments, the computing device(s) may be associated with one or more of the shipper entities 101, 102, 103.

Although FIG. 1 depicts the server 110 in communication with the ELD provider 112 and the set of shipper entities 101, 102, 103, it should be appreciated that alternative configurations are envisioned. In one particular implementation, the server 110 may be an entity separate from the TMS and the 3PL entity.

Although not depicted in FIG. 1, the system 100 may support one or more computer networks that may enable communication between and among the entities and components of the system 100. In embodiments, the computer network(s) may support any type of wired or wireless data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others). For example, the set of shipper entities 101, 102, 103 may communicate with the server 110 (and/or with the equipment ID matching module 111) via an Internet connection.

It should be appreciated that the components and entities of the system 100 may include and support various combinations of hardware and software components capable of facilitating various of the functionalities of the systems and methods. For example, the components and entities of the system 100 may generally support one or more computer processors, communication modules (e.g., transceivers), memories, and/or other components.

FIG. 2 depicts a signal diagram 200 including various functionalities associated with the described embodiments. The signal diagram 200 includes a shipper server 201 (such as a server associated with one of the set of shipper entities 101, 102, 103), a server 210 (such as the server 110 as described with respect to FIG. 1), and an ELD provider 212 (such as the ELD provider 112 as described with respect to FIG. 1).

The signal diagram 200 may begin when the server 210 accesses and/or generates (220) training data. Generally, the training data may include labeled data that matches a first equipment ID (e.g., an equipment ID that would normally be provided by a shipper entity or a customer) with a second equipment ID (e.g., an equipment ID that would normally be reflected or stored in a system of a carrier entity).

In embodiments, the training data may include a set of positive cases and a set of negative cases. The set of positive cases may include equipment IDs that were previously matched organically or manually, or automatically using software or algorithm, where each of the set of positive cases may have resulted in a corresponding tracked shipment. According to embodiments, each of the set of positive cases may be labeled with an indication that the corresponding pairing is positively (i.e., correctly) matched, and thus constitutes the target outcome for a trained machine learning model.

The set of negative cases may include pairs of equipment IDs that are initially matched and then are intentionally mismatched. For example, a set of negative cases may be a set of customer/shipper-provided equipment IDs initially matched with a set of carrier-provided equipment IDs, and then scrambling/rearranging the matched pairings such that the resulting pairings are mismatched. The set of negative cases may alternatively or additionally include augmented or modified text. In particular, a negative case may include a carrier-provided equipment ID having some of its characters scrambled, or replaced with other characters (e.g., random alphanumeric characters). According to embodiments, each of the set of negative cases may be labeled with an indication that the corresponding pairing is negatively (i.e., incorrectly) matched. Generally, the set of negative cases may signify linkages that the trained machine learning model should avoid. Further, by virtue of both the set of positive cases and the set of negative cases, the training data is balanced such that the machine learning model may learn any subtle patterns that distinguish reliable equipment ID matches from mismatches or misaligned assignments that the machine learning model should automatically detect.

According to embodiments, the training data may include a set of features that represent characteristics or properties of a given string. For example, the set of features may include various string characteristics including: len_automatic: length of the candidate match string; len_customer: length of customer-provided string; len_num_automatic: length of numeric characters in candidate match string; len_num_customer: length of numeric characters in customer-provided string; len_alpha_automatic: length of alphabet characters in candidate match string; len_alpha_customer: length of alphabet characters in customer-provided string; len_punc_automatic: length of punctuation characters, if any, in candidate match string; and len_punc_customer: length of punctuation characters, if any, in customer-provided string.

For further example, the training data may include a set of ID-type characteristics including: phone_customer: an indication of whether a telephone number is found anywhere in customer-provided string; phone_automatic: an indication of whether a telephone number is found anywhere in candidate match string; ids_match: whether the ID type field matches between the customer-provided and candidate match strings; AUTOMATIC_VID: whether the ID type of the candidate match string is Vehicle ID; CUSTOMER_VID: whether the ID type of the customer-provided string is Vehicle ID; AUTOMATIC_LIC: whether the ID type of the candidate match string is License Plate; and CUSTOMER_LIC: whether the ID type of the customer-provided string is License Plate.

Further, for example, the training data may include various fuzzy matching comparisons including: ratio: fuzzy match levenshtein distance; token_sort_ratio: a variation on levenshtein distance; token_set_ratio: a variation on levenshtein distance; cproc_ratio: when customer-provided string is processed to remove punctuation and separate numeric and alpha tokens, levenshtein distance; cproc_token_sort_rati; cproc_token_set_ratio; aproc_ratio: when customer-provided string and candidate match string are both processed to remove punctuation and separate numeric and alpha tokens, levenshtein distance; aproc_token_sort_ratio; aproc_token_set_ratio; alpha_ratio: levenshtein distance for alpha characters; alpha_token_sort_ratio; alpha_token_set_ratio; num_ratio: levenshtein distance for numeric characters; num_token_sort_ratio; num_token_set_ratio; aproc_token_set_high: whether the aproc_token_set ratio is higher than 95; and aproc_token_sort_high: whether the aproc_token_sort ratio is higher than 95. It should be appreciated that alternative and additional string characteristics, ID-type characteristics, and fuzzy matching characteristics are envisioned.

In embodiments, the training data may include various filtering variations including, for example: sampling to get even numbers of positive and negative, or not; splitting train/test on different characteristics (customer-provided ID, matching ID); requiring equipment ID types to be the same, or not; requiring cases to have at least 25 fuzzy match score, or not; and minimum allowed length of customer-provided ID (e.g., 1, 2, 3, 4).

The server 210 may train (222) a machine learning model using the training data. According to embodiments, the server 210 may initialize and iterate on the design of an architecture, such as a deep neural network model architecture, that is specialized to the training data. In particular, through experimentation with different network layouts and hyperparameters, the server 210 may converge on a given machine learning model. For example, the server 210 may determine that a convolutional neural network (CNN) containing custom layers tailored to the matched/mismatched equipment IDs outperforms one or more baseline models. Generally, the server 210 may make various architectural decisions such as the number of nodes per layer, activation functions, dropout rate, and loss objective.

When the server 210 has defined an optimized model architecture, the server 210 may pass the training data containing properly conjoined and scrambled equipment ID pairs through iterative training. By continuously exposing the machine learning model to properly-matched positive samples and improperly-matched negative samples, the server 210 may update internal weights (e.g., using stochastic gradient descent) reaching a high predictive accuracy, such as on previously unseen data. When the machine learning model is trained, the server 210 may validate performance of the machine learning model to check for overfitting. Additionally, when the machine learning model is trained, the server 210 may use the trained machine learning model to analyze data.

The shipper server 201 may provide (224) a set of equipment IDs to the server 210. In embodiments, the set of equipment IDs may be associated with one or more shipping agreements associated with the transportation of products. It should be appreciated that the set of equipment IDs may be provided in associated with different situations or conditions, such as if the server 210 facilitates purchase or leasing of equipment for a fleet associated with the shipper, during the server 210 onboarding the shipper as a new transportation client, via a device belonging to a driver or operator of the equipment, or during yard system integration in which the shipper may transmit equipment IDs directly from its own TMS into the server 210 via routine data integration. It should be appreciated that the shipper server 201 may provide multiple equipment IDs to the server 210.

The server 210 may input (226) the equipment ID into the trained machine learning model. According to embodiments, the machine learning model may initially extract relevant features or characters from the equipment ID, and may encode these extracted features into a format that the machine learning model can understand (e.g., by transforming categorical variables into numerical representations, scaling values, or using other techniques to prepare the data for analysis). The encoded information may be fed into the trained machine learning model, which has learned patterns and relationships from the training data which includes both correctly- and incorrectly-matched equipment IDs.

The trained machine learning model may output (228) a set of possible equipment ID matches based on its analysis of the inputted equipment ID. Generally, each of the set of possible equipment ID matches that is output by the trained machine learning model may represent an equipment ID that is expected by, or otherwise matches a record of, the carrier and/or the ELD provider 212. In other words, the possible equipment ID match may represent the correct or accurate identification of the equipment corresponding to the equipment ID that the shipper server 201 provides in (224).

In embodiments, the set of possible equipment ID matches may be ranked in order of probability of match to an equipment ID of the carrier, where each of the set of possible equipment ID matches may (or may not) exceed a threshold probability value (e.g., 70% or another value). Generally, if a given possible equipment ID match is different from the equipment ID provided in (224), this may be due to the trained machine learning model adjusting or modifying certain characters of the equipment ID provided in (224) to align more closely with patterns observed in accurately-matched identifications.

According to embodiments, the trained machine learning model may be a certain type of model. For example, the trained machine learning model may be a probability matching classifier model that, during its prediction process, outputs class probabilities that match the true class probabilities in the training data. Further, for example, the trained machine learning model may output a set of results according to a ranking strategy that ranks outputs in order of importance, relevance, or preference.

The server 210 may assess/confirm (230) the set of possible equipment ID matches. In embodiments, the server 210 may interface with an API of the carrier to initially test the possible equipment ID match having the highest probability. If the API does not return an equipment ID that matches this possible equipment ID match, the server 210 may test, with the API of the carrier, the possible equipment ID match having the next highest probability. The server 210 may continue this testing until the tested possible equipment ID match matches an equipment ID of the carrier, in which case the server 210 may record this possible equipment ID match. If the server 210 does not match any of the set of possible equipment ID matches, the server 210 may record that a match was not located. In this situation, processing may repeat, end, or proceed to other functionality. For example, the server 210 may repeat the analysis by the machine learning model.

In the situation in which an equipment ID of the carrier is matched with a possible equipment ID match as output by the machine learning model, the server 210 may request (232) the ELD provider 212 to provide tracking information associated with the equipment associated with the equipment ID. In embodiments, the server 210 may submit the equipment ID via a portal or API, where the equipment may be, for example, a trailer, container, or vehicle. The ELD provider 212 may verify that the equipment ID corresponds to or matches an active tracking device ID installed in an equipment.

The ELD provider 212 may provide (234) tracking information associated with the equipment. In particular, upon confirming a successful equipment ID and device ID match, the ELD provider 212 may enable a real-time tracking data feed for that equipment ID to start flowing to the server 210, where the server 210 may specify data feed parameters (e.g., update frequency, reporting protocol (FTP, API), file formatting, specific telemetry fields requiring capture such as temperature and door events, etc.). In embodiments, the paired ELD device may start continuously relaying, to the server 210, various data information, including location coordinates, utilization events, and sensor values, via automated updates.

The server 210 may process/avail (236) the tracking information. In particular, the server 210 may ingest the live ELD feeds by integrating the streaming location and sensor information tied to the original equipment ID into its transportation management system for visibility, such as by its customers.

The server 210 may update (238) the machine learning model. In particular, the server 210 may update the machine learning model based on whether the output from (228) matches an equipment ID from (230). Accordingly, the server 210 may employ the machine learning model that was updated in subsequent analyses of equipment IDs provided by the shipper server 201. The updating of the machine learning model may include retraining the machine learning model with the results of (230). That is, the results of (230) along with the equipment ID provided in (224) may be additional training data that the server 210 may use to retrain the machine learning model.

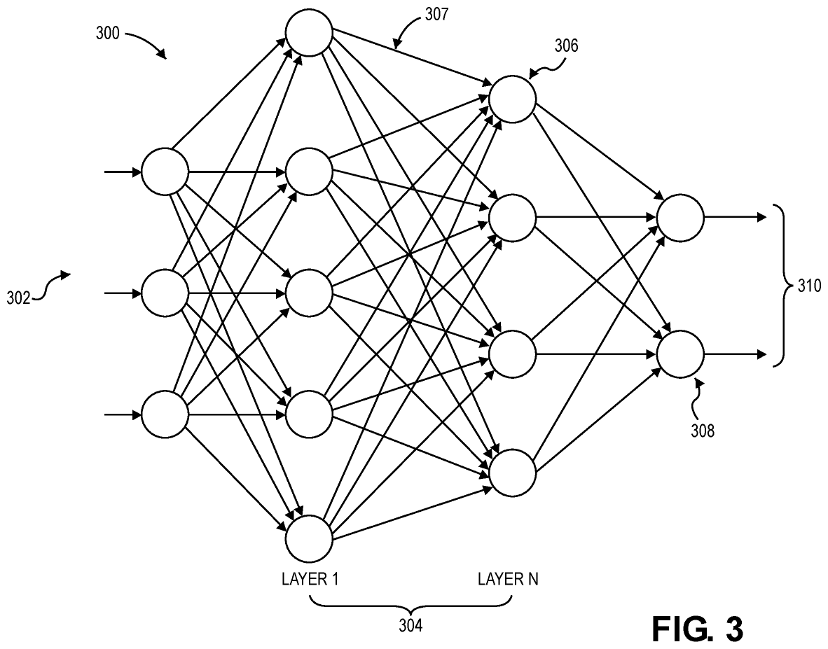

FIG. 3 depicts an exemplary deep learning artificial neural network (DNN) 300, which may be used in conjunction with the machine learning techniques as discussed herein. The DNN 300 may be trained and/or operated by a server (e.g., the server 110, 210 of respective FIGS. 1 and 2). The DNN 300 may include a plurality of layers, each of which may include any number of respective neurons, or nodes.

The DNN 300 may include an input layer 302, one or more hidden layers 304, and an output layer 308. Each of the layers in the DNN may include an arbitrary number of neurons. The plurality of layers may chain neurons together linearly and may pass output from one neuron to the next, or may be networked together such that the neurons communicate input and output in a non-linear way. In general, it should be understood that many configurations and/or connections of DNNs are possible.

The input layer 302 may correspond to a large number of input parameters (e.g., one million inputs), in some embodiments, and may be analyzed serially or in parallel. Further, various neurons and/or neuron connections within the DNN may be initialized with any number of weights and/or other training parameters. Each of the neurons in the hidden layers 304 may analyze one or more of the input parameters from the input layer 302, and/or one or more outputs from a previous one or more of the hidden layers 304, to generate a decision 310 or other output. The output layer 308 may generate the decision 310 or more outputs, each indicating a prediction or an expected value. The number of input neurons may be stored as a predetermined value, and used to initialize a network for training.

In some embodiments and/or scenarios, the output layer 308 may include only a single output 310. For example, a neuron may correspond to one of the neurons in a hidden layer 306. Each of the inputs to the neuron may be weighted according to a set of weights W1 through Wi (as represented by 307 in FIG. 3), determined during the training process (for example, if the neural network is a recurrent neural network) and then applied to a node that performs an operation α. The operation α may include computing a sum, a difference, a multiple, or a different operation. In some embodiments weights are not determined for some inputs. In some embodiments, neurons of weight below a threshold value may be discarded/ignored. The sum of the weighted inputs, r1, may be input to a function which may represent any suitable functional operation on r1. The output of the function may be provided to a number of neurons of a previous/subsequent layer or as an output 310 of the DNN. In some embodiments, the DNN may include one or more convolutional neural network (CNN) layers.

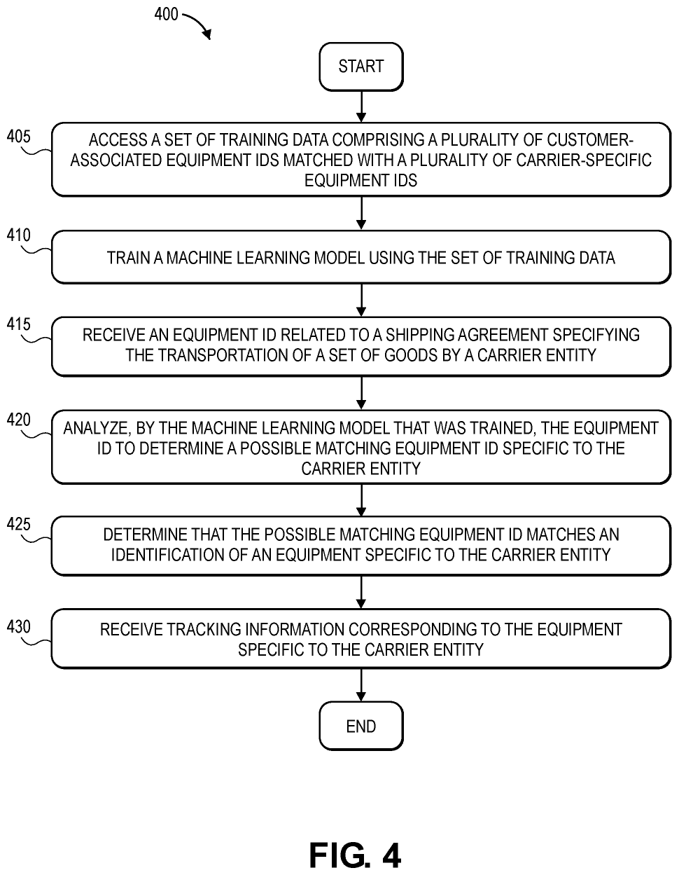

FIG. 4 depicts a block diagram of an example method 400 of employing machine learning to track shipping equipment. The method 400 may be facilitated by an electronic device (such as the server 110, 210 as respectively discussed with respect to FIGS. 1 and 2). In embodiments, the electronic device may communicate with various data sources, servers, devices, and/or the like, where the electronic device may include one or more local or distributed servers that may include one or more local and/or distributed processors.

The method 400 may begin at block 405 in which the electronic device may access a set of training data that may include a plurality of customer-associated equipment IDs matched with a plurality of carrier-specific equipment IDs. The electronic device may train (block 410) a machine learning model using the set of training data. According to embodiments, the set of training data may include a set of correctly-matched equipment IDs and a set of incorrectly-matched equipment IDs. Further, training the machine learning model may include continuously exposing the machine learning model to the set of correctly-matched equipment IDs and the set of incorrectly-matched equipment IDs, and based on the continuously exposing, updating a set of internal weights for the machine learning model.

The electronic device may receive (block 415) an equipment ID related to a shipping agreement specifying the transportation of a set of goods by a carrier entity. Further, the electronic device may analyze (block 420), by the machine learning model that was trained, the equipment ID to determine a possible matching equipment ID specific to the carrier entity. According to embodiments, the electronic device may analyze, by the machine learning model that was trained, the equipment ID to determine a plurality of possible matching equipment IDs specific to the carrier entity, where the plurality of possible matching equipment IDs may be ordered according to a respective probability that each of the plurality of possible matching equipment IDs matches the identification of the equipment specific to the carrier entity.

The electronic device may determine (block 425) that the possible matching equipment ID matches an identification of an equipment specific to the carrier entity. In embodiments, the electronic device may determine, via an API associated with the carrier entity, that the possible matching equipment ID matches the identification of the equipment specific to the carrier entity. Further, in embodiments, if there are a plurality of possible matching equipment IDs, the electronic device may determine that a first possible matching equipment ID, of the plurality of possible matching equipment IDs, having the highest probability does not match the identification of the equipment specific to the carrier entity, and determine that a second possible matching equipment ID, of the plurality of possible matching equipment IDs, having the next highest probability does match the identification of the equipment specific to the carrier entity

The electronic device may receive (block 430) tracking information corresponding to the equipment specific to the carrier entity. In embodiments, the electronic device may request an ELD provider to provide the tracking information corresponding to the equipment specific to the carrier entity, and receive, from the ELD provider, the tracking information. Further, in embodiments, the electronic device may receive, according to a set of data feed parameters, the tracking information corresponding to the equipment specific to the carrier entity. Additionally, in embodiments, the electronic device may update the machine learning model based on the possible matching equipment ID matching the identification of the equipment specific to the carrier entity.

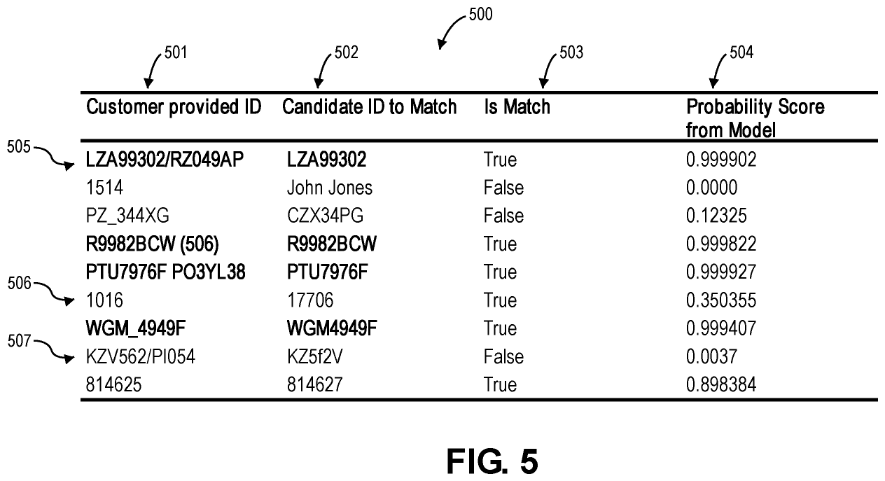

FIG. 5 is an example table 500 including sets of equipment IDs along with results of respective machine learning model analyses. As illustrated in the table 500, a first column 501 includes customer-associated equipment IDs that are provided by a customer or shipper (i.e., the machine learning model input); a second column 502 includes candidate matching equipment IDs that are output by the machine learning model; a third column 503 includes indications of whether the corresponding candidate matching equipment IDs match equipment IDs of the carrier entity; and a fourth column 504 includes probabilities, as calculated by the machine learning model, that the corresponding candidate matching equipment IDs match equipment IDs of the carrier entity.

For example, row 505 includes the customer-associated equipment ID “LZA99302/RZ049AP”, the candidate matching equipment ID “LZA99302”, the matching indication of “True”, and a calculated probability of 0.999902. For further example, row 506 includes the customer-associated equipment ID “1016”, the candidate matching equipment ID “17706”, the matching indication of “True”, and a calculated probability of 0.350355. In this example, although the calculated probability was only about 35%, the candidate matching equipment ID as output by the machine learning model actually matched an equipment ID of the carrier entity, therefore the matching indication is “True.” Further, for example, row 507 includes the customer-associated equipment ID “KZV562/PI054”, the candidate matching equipment ID “KZ5f2V”, the matching indication of “False”, and a calculated probability of 0.0037. In this example, the candidate matching equipment ID did not match an equipment ID of the carrier entity.

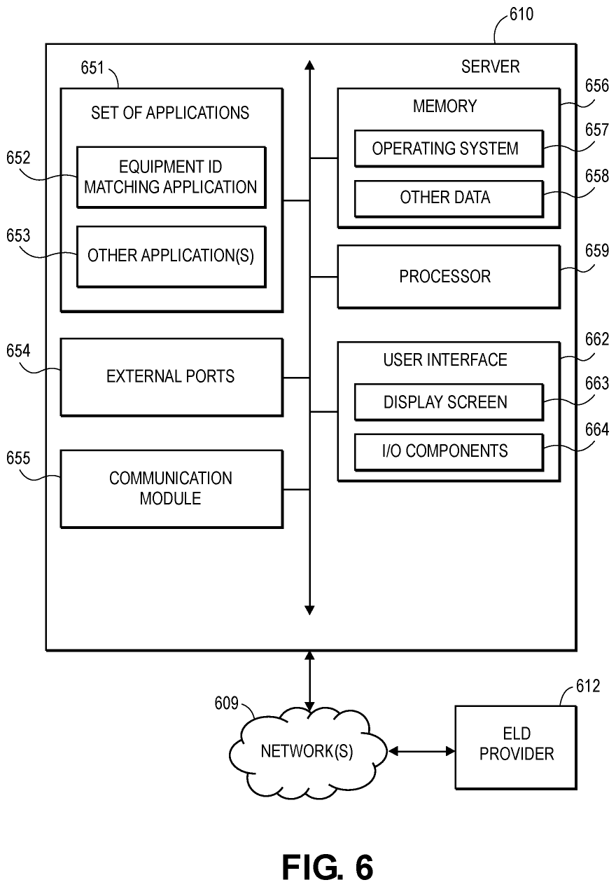

FIG. 6 illustrates a hardware diagram of an example server 610 (e.g., the server 210 as described with respect to FIG. 2), in which the functionalities as discussed herein may be implemented.

As illustrated in FIG. 6, the server 610 may include a processor 659 as well as a memory 656. The memory 656 may store an operating system 657 capable of facilitating the functionalities as discussed herein as well as a set of applications 651 (i.e., machine readable instructions). For example, one of the set of applications 651 may be an equipment ID matching application 652, such as to train a machine learning model and use the train machine learning model to match customer-provided equipment IDs to equipment IDs associated with carriers. It should be appreciated that one or more other applications 653 are envisioned.

The processor 659 may interface with the memory 656 to execute the operating system 657 and the set of applications 651. According to some embodiments, the memory 656 may also store other data 658, such as machine learning model data (including training data), equipment tracking data, and/or other data. The memory 656 may include one or more forms of volatile and/or nonvolatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 610 may further include a communication module 655 configured to communicate data via one or more networks 609. According to some embodiments, the communication module 655 may include one or more transceivers (e.g., WAN, WWAN, WLAN, and/or WPAN transceivers) functioning in accordance with IEEE standards, 3GPP standards, or other standards, and configured to receive and transmit data via one or more external ports 654. In particular, the communication module 655 of the server 610 may interface with an ELD provider 612 that may communicate with a set of location tracking device(s) (and/or additional devices) via the network(s) 609 and the set of external ports 654.

The server 610 may further include a user interface 662 configured to present information to a user and/or receive inputs from the user. As shown in FIG. 6, the user interface 662 may include a display screen 663 and I/O components 664 (e.g., ports, capacitive or resistive touch sensitive input panels, keys, buttons, lights, LEDs, external or built in keyboard). According to some embodiments, the user may access the server 610 via the user interface 662 to review information, make selections, and/or perform other functions.

In some embodiments, the server 610 may perform the functionalities as discussed herein as part of a “cloud” network or may otherwise communicate with other hardware or software components within the cloud to send, retrieve, or otherwise analyze data. Further, in embodiments, the server 610 may support operation of a desktop or mobile application which may enable remote administration of the cloud data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 659 (e.g., working in connection with the operating system 657) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some embodiments, the computer program product may be part of a cloud network of resources.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate or additional embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

What is claimed is:

1. A computer-implemented method of employing machine learning to track shipping equipment, the computer-implemented method comprising:
accessing a set of training data comprising a plurality of customer-associated equipment identifications (IDs) matched with a plurality of carrier-specific equipment IDs;
training, by at least one processor, a machine learning model using the set of training data;
receiving, by the at least one processor, an equipment ID related to a shipping agreement specifying the transportation of a set of goods by a carrier entity;
analyzing, by the machine learning model that was trained, the equipment ID to determine a possible matching equipment ID specific to the carrier entity;
determining, by the at least one processor, that the possible matching equipment ID matches an identification of an equipment specific to the carrier entity; and
receiving, by the at least one processor, tracking information corresponding to the equipment specific to the carrier entity, wherein the tracking information is generated by a tracking device installed in the equipment specific to the carrier entity.

2. The computer-implemented method of claim 1, wherein analyzing the equipment ID comprises:
analyzing, by the machine learning model that was trained, the equipment ID to determine a plurality of possible matching equipment IDs specific to the carrier entity.

3. The computer-implemented method of claim 2, wherein the plurality of possible matching equipment IDs is ordered according to a respective probability that each of the plurality of possible matching equipment IDs matches the identification of the equipment specific to the carrier entity.

4. The computer-implemented method of claim 3, wherein determining that the possible matching equipment ID matches the identification of the equipment specific to the carrier entity comprises:
determining that a first possible matching equipment ID, of the plurality of possible matching equipment IDs, having the highest probability does not match the identification of the equipment specific to the carrier entity; and
determining that a second possible matching equipment ID, of the plurality of possible matching equipment IDs, having the next highest probability does match the identification of the equipment specific to the carrier entity.

5. The computer-implemented method of claim 1, wherein determining that the possible matching equipment ID matches the identification of the equipment specific to the carrier entity comprises:
determining, by the at least one processor via an application programming interface (API) associated with the carrier entity, that the possible matching equipment ID matches the identification of the equipment specific to the carrier entity.

6. The computer-implemented method of claim 1, further comprising:
updating, by the at least one processor, the machine learning model based on the possible matching equipment ID matching the identification of the equipment specific to the carrier entity.

7. The computer-implemented method of claim 1, wherein the set of training data comprises a set of correctly-matched equipment IDs and a set of incorrectly-matched equipment IDs, and wherein training the machine learning model comprises:
continuously exposing, by the at least one processor, the machine learning model to the set of correctly-matched equipment IDs and the set of incorrectly-matched equipment IDs; and
based on the continuously exposing, updating a set of internal weights for the machine learning model.

8. The computer-implemented method of claim 1, wherein receiving the tracking information corresponding to the equipment specific to the carrier entity comprises:
requesting, by the at least one processor, an electronic logging device (ELD) provider to provide the tracking information corresponding to the equipment specific to the carrier entity; and
receiving, by the at least one processor from the ELD provider, the tracking information.

9. The computer-implemented method of claim 1, wherein receiving the tracking information corresponding to the equipment specific to the carrier entity comprises:
receiving, by the at least one processor according to a set of data feed parameters, the tracking information corresponding to the equipment specific to the carrier entity.

10. A system for employing machine learning to track shipping equipment, comprising:
a memory storing (i) a set of computer-readable instructions, and (ii) a set of training data comprising a plurality of customer-associated equipment identifications (IDs) matched with a plurality of carrier-specific equipment IDs; and
at least one processor interfaced with the memory, and configured to execute the set of computer-readable instructions to cause the at least one processor to:
train a machine learning model using the set of training data,
receive an equipment ID related to a shipping agreement specifying the transportation of a set of goods by a carrier entity,
analyze, by the machine learning model that was trained, the equipment ID to determine a possible matching equipment ID specific to the carrier entity,
determine that the possible matching equipment ID matches an identification of an equipment specific to the carrier entity, and
receive tracking information corresponding to the equipment specific to the carrier entity, wherein the tracking information is generated by a tracking device installed in the equipment specific to the carrier entity.

11. The system of claim 10, wherein the at least one processor analyzes, by the machine learning model that was trained, the equipment ID to determine a plurality of possible matching equipment IDs specific to the carrier entity.

12. The system of claim 11, wherein the plurality of possible matching equipment IDs is ordered according to a respective probability that each of the plurality of possible matching equipment IDs matches the identification of the equipment specific to the carrier entity.

13. The system of claim 12, wherein to determine that the possible matching equipment ID matches the identification of the equipment specific to the carrier entity, the at least one processor is configured to:
determine that a first possible matching equipment ID, of the plurality of possible matching equipment IDs, having the highest probability does not match the identification of the equipment specific to the carrier entity, and
determine that a second possible matching equipment ID, of the plurality of possible matching equipment IDs, having the next highest probability does match the identification of the equipment specific to the carrier entity.

14. The system of claim 10, wherein to determine that the possible matching equipment ID matches the identification of the equipment specific to the carrier entity, the at least one processor is configured to:
determine, via an application programming interface (API) associated with the carrier entity, that the possible matching equipment ID matches the identification of the equipment specific to the carrier entity.

15. The system of claim 10, wherein the at least one processor is configured to execute the set of computer-readable instructions to further cause the at least one processor to:
update the machine learning model based on the possible matching equipment ID matching the identification of the equipment specific to the carrier entity.

16. The system of claim 10, wherein the set of training data comprises a set of correctly-matched equipment IDs and a set of incorrectly-matched equipment IDs, and wherein to train the machine learning model, the at least one processor is configured to:
continuously expose the machine learning model to the set of correctly-matched equipment IDs and the set of incorrectly-matched equipment IDs, and
based on the continuously exposing, update a set of internal weights for the machine learning model.

17. The system of claim 10, wherein to receive the tracking information corresponding to the equipment specific to the carrier entity, the at least one processor is configured to:
request an electronic logging device (ELD) provider to provide the tracking information corresponding to the equipment specific to the carrier entity, and
receive, from the ELD provider, the tracking information.

18. The system of claim 10, wherein to receive the tracking information corresponding to the equipment specific to the carrier entity, the at least one processor is configured to:
receive, according to a set of data feed parameters, the tracking information corresponding to the equipment specific to the carrier entity.

19. A non-transitory computer-readable storage medium configured to store instructions executable by a computer processor, the instructions comprising:
instructions for accessing a set of training data comprising a plurality of customer-associated equipment identifications (IDs) matched with a plurality of carrier-specific equipment IDs;
instructions for training a machine learning model using the set of training data;
instructions for receiving an equipment ID related to a shipping agreement specifying the transportation of a set of goods by a carrier entity;
instructions for analyzing, by the machine learning model that was trained, the equipment ID to determine a possible matching equipment ID specific to the carrier entity;
instructions for determining that the possible matching equipment ID matches an identification of an equipment specific to the carrier entity; and
instructions for receiving tracking information corresponding to the equipment specific to the carrier entity, wherein the tracking information is generated by a tracking device installed in the equipment specific to the carrier entity.

20. The non-transitory computer-readable storage medium of claim 19, wherein the set of training data comprises a set of correctly-matched equipment IDs and a set of incorrectly-matched equipment IDs, and wherein the instructions for training the machine learning model comprise:
instructions for continuously exposing the machine learning model to the set of correctly-matched equipment IDs and the set of incorrectly-matched equipment IDs; and
instructions for, based on the continuously exposing, updating a set of internal weights for the machine learning model.
